(19) United States
(12) Patent Application Publication
(10) Pub. No.: US 2026/0260160 A1
(43) Pub. Date: Sep. 3, 2026

(54) METHOD FOR IMPROVING THE ACCURACY OF A MACHINE LEARNING MODEL

(71) Applicant: Intuit Inc., Mountain View, CA (US)

(72) Inventors: Tharathorn RIMCHALA, San Francisco, CA (US); Matthew BERNSTEIN, Philadelphia, PA (US); Peter CATON ANTHONY, Menlo Park, CA (US); Shir MEIR LADOR, Hod HaSharon (IL); Sparsh GUPTA, San Diego, CA (US)

(73) Assignee: Intuit Inc., Mountain View, CA (US)

(21) Appl. No.: 19/067,755

(22) Filed: Feb. 28, 2025

(51) Int. Cl. G06N 20/00

(52) U.S. Cl. CPC G06N 20/00

(57) ABSTRACT

A method including receiving an initial dataset of data points and a sampled dataset including a sampling of data in a second dataset. Identified are a first number of subpopulations in the initial dataset and a second number of subpopulations in the sampled dataset corresponding to the first number of subpopulations. A measure of representativeness is identified using the first number of subpopulations in the initial dataset and the second number of subpopulations in the sampled dataset. A measure of coverage of the sampled dataset is identified relative to the initial dataset. An initial machine learning model is executed on the sampled dataset based on thresholds to generate a number of outputs corresponding to the subpopulations. A number of accuracies of the initial machine learning model are determined for the second number of subpopulations. The sampled dataset is remediated. The initial machine learning model is retrained.

### BACKGROUND

The accuracy of machine learning models depends heavily on the data used to train the machine learning models. In some cases, a machine learning model may be trained on a sampling of an initial dataset.

However, the sampling may not be representative of all subgroups of data within the initial dataset. For example, assume the initial dataset has three subgroups of data: a first group represents 5% of the initial dataset, a second group represents 25% of the initial dataset, and a third group represents 70% of the initial dataset. Further assume that, after sampling the initial dataset, the first group represents 20% of the sampling dataset, the second group represents 10% of the sampling dataset, and the third group represents 70% of the sampling dataset. In this example, in the sampling dataset, the first group is significantly overrepresented and the second group is significantly underrepresented, relative to the initial dataset.

If a machine learning model is trained on the sampling dataset, but executed on a remaining portion of the initial dataset, then the machine learning model may produce inaccurate output. The reason why the output is inaccurate is because the sampling dataset is not representative of the initial dataset leading to improperly selected weights or parameters in the machine learning model.

However, the determination of representativeness of the sampling dataset, relative to the initial dataset, is difficult or in some cases impracticable. As a result, a machine learning model trained on a sampling dataset may be inaccurate. Techniques for improving the accuracy of machine learning models are sought.

### SUMMARY

One or more embodiments provide for a method. The method includes receiving an initial dataset of data points and a sampled dataset including a sampling of data in a second dataset. The method also includes identifying a first number of subpopulations in the initial dataset and a second number of subpopulations in the sampled dataset corresponding to the first number of subpopulations. The method also includes identifying a measure of representativeness using the first number of subpopulations in the initial dataset and the second number of subpopulations in the sampled dataset. The method also includes identifying a measure of coverage of the sampled dataset relative to the initial dataset. The method also includes executing, responsive to one of the measure of representativeness failing to satisfy a first threshold and the measure of coverage failing to satisfy a second threshold, an initial machine learning model on the sampled dataset. Executing generates a number of outputs corresponding to the second number of subpopulations. The method also includes determining, using the number of outputs, a number of accuracies of the initial machine learning model for the second number of subpopulations. The method also includes determining that at least one of the number of accuracies fails to satisfy a corresponding subpopulation accuracy difference threshold. The method also includes remediating, responsive to the accuracy failing to satisfy the corresponding subpopulation accuracy difference threshold, the sampled dataset to generate a remediation dataset. The method also includes retraining the initial machine learning model using the remediation dataset to return a retrained machine learning model.

One or more embodiments also provide for a system. The system includes a computer processor and a data repository in communication with the computer processor. The data repository stores an initial dataset of data points. The data repository also stores a sampled dataset including a sampling of data in a second dataset. The data repository also stores a first number of subpopulations in the initial dataset. The data repository also stores a second number of subpopulations in the sampled dataset corresponding to the first number of subpopulations. The data repository also stores a measure of representativeness having a first threshold. The data repository also stores a measure of coverage of the sampled dataset relative to the initial dataset, having a second threshold. The data repository also stores a number of outputs corresponding to the second number of subpopulations. The data repository also stores a number of accuracies of an initial machine learning model for the second number of subpopulations. The data repository also stores a remediation dataset. The system also includes the initial machine learning model which, when executed by the computer processor on the sampled dataset responsive to one of the measure of representativeness failing to satisfy the first threshold and the measure of coverage failing to satisfy the second threshold, generates the number of outputs. The system also includes a retrained machine learning model executable by the computer processor. The system also includes a server controller in communication with the computer processor which, when executed by the computer processor performs a computer-implemented method. The computer-implemented method also identifies the initial dataset, the sampled dataset, the first number of subpopulations, the second number of subpopulations. The computer-implemented method also identifies the measure of representativeness using the first number of subpopulations and the second number of subpopulations. The computer-implemented method also identifies the measure of coverage. The computer-implemented method also determines the number of accuracies using the number of outputs of the initial machine learning model. The computer-implemented method also determines that at least one of the number of accuracies fails to satisfy a corresponding subpopulation accuracy difference threshold. The computer-implemented method also remediates, responsive to the accuracy failing to satisfy the corresponding subpopulation accuracy difference threshold, the sampled dataset to generate the remediation dataset. The system also includes a training controller in communication with the computer processor which, when executed by the computer processor, retrains the initial machine learning model using the remediation dataset to return the retrained machine learning model.

One or more embodiments provide for another method. The method includes receiving an initial dataset of data points and a sampled dataset including a sampling of data in a second dataset. The method also includes identifying a first number of subpopulations in the initial dataset and a second number of subpopulations in the sampled dataset corresponding to the first number of subpopulations. The method also includes identifying a measure of representativeness using the first number of subpopulations in the initial dataset and the second number of subpopulations in the sampled dataset by comparing first numbers of data points within each of the first number of subpopulations to second numbers of data points within each of the second number of subpopulations. Comparing generates relative proportions of the first numbers to the second numbers for at least one pair of subpopulations. The at least one pair of subpopulations each include one member of the first number of subpopulations and another member of the second number of subpopulations. The measure of representativeness includes the relative proportions for each of the at least one pair of subpopulations. The method also includes identifying a measure of coverage of the sampled dataset relative to the initial dataset by identifying at least one pair of subpopulation. The at least one pair of subpopulations each include one member of the first number of subpopulations and another member of the second number of subpopulations. Identifying the measure of coverage further includes identifying a fraction of the at least one pair of subpopulations that have no underrepresentation. A pair of the at least one pair of subpopulations has no underrepresentation when the measure of representativeness of the pair is greater than a representativeness threshold. The method also includes executing, responsive to one of the measure of representativeness failing to satisfy a first threshold and the measure of coverage failing to satisfy a second threshold, an initial machine learning model on the sampled dataset. Executing generates a number of outputs corresponding to the second number of subpopulations. The method also includes determining, using the number of outputs, a number of accuracies of the initial machine learning model for the second number of subpopulations. The method also includes determining that at least one of the number of accuracies fails to satisfy a corresponding subpopulation accuracy difference threshold. The method also includes remediating, responsive to the accuracy failing to satisfy the corresponding subpopulation accuracy difference threshold, the sampled dataset to generate a remediation dataset by performing at least one of sampling a new dataset and re-sampling the initial dataset to cause the measure of coverage for the remediated dataset to satisfy the second threshold. The method also includes retraining the initial machine learning model using the remediation dataset to return a retrained machine learning model.

Other aspects of one or more embodiments will be apparent from the following description and the appended claims.

### BRIEF DESCRIPTION OF DRAWINGS

FIG. 1A and FIG. 1B show a computing system, in accordance with one or more embodiments.

FIG. 2 shows a flowchart of a method for improving the accuracy of a machine learning model, in accordance with one or more embodiments.

FIG. 3 shows an example of improving the accuracy of a machine learning model, in accordance with one or more embodiments.

FIG. 4A and FIG. 4B show a computing system and network environment, in accordance with one or more embodiments.

Like elements in the various figures are denoted by like reference numerals for consistency.

### DETAILED DESCRIPTION

One or more embodiments are directed to a technical solution to the technical problem of inaccurate machine learning models caused by training the machine learning models on unrepresentative sampling datasets. Stated differently, one or more embodiments described herein relate to a technical solution of improving the accuracy of machine learning models by training or retraining a machine learning model on a remediation dataset that has, within an acceptable uncertainty, the representativeness and coverage of the initial dataset. One or more embodiments provide for techniques for determining the representativeness and coverage of a sampling dataset, remediating an unrepresentative sampling dataset to generate a remediation dataset, and then retraining the machine learning model on the remediation dataset. As a result, the machine learning model is improved in that the trained (or retrained) machine learning model is improved.

Stated differently, having a sampling dataset that reflects subpopulations of the initial dataset is useful in evaluating and understanding whether an evaluation result of a machine learning model is generalizable to runtime performance across different subpopulations of data points in the initial dataset. Standard evaluation dataset curation processes rely on a random sampling of data points from the initial dataset. Historically, there is difficulty in quantifying whether the resulting sampling dataset, 1) sufficiently covers the distribution of data in the initial dataset, and 2) has about equivalent representations of subpopulations relative to the initial dataset. Additionally, historically, the unused (i.e., unsampled) portions of the initial dataset should be distinct from any sampling datasets used to train machine learning models, as the unused portions of the initial dataset are used to evaluate the performance of the machine learning model.

Therefore, one or more embodiments have recognized two useful factors used in the process of generating a remediation dataset. A first factor is a method for determining quantitative measurements of representativeness and coverage of a sampling dataset with respect to an initial dataset. A second factor is a method for sampling the initial dataset to assemble a remediation dataset that maximizes subpopulation representation and population coverage.

Representativeness is defined as the relative proportion of individual subpopulations in the sampling dataset compared to the initial dataset. Coverage is defined as the fraction of subpopulations that have no underrepresentation in the sampling dataset, relative to the initial dataset. Coverage is based on a threshold of the representation differences in subpopulations between the initial dataset and the sampling dataset. Stated differently, representativeness compares whether proportions between individual subpopulations differ by more than a predetermined amount, whereas coverage is a measure of the number of subpopulations in the sampling dataset where the proportion meets a minimum threshold.

The quantitative measures of representativeness and coverage, as defined above, can be used as a tool to evaluate existing sampling datasets and to thereby improve the accuracy of a machine learning model. The proposed sampling approach can be used to assemble remediation datasets for sampling datasets that have deficient representativeness or deficient coverage. The remediation datasets can then be used to train, or retrain, machine learning models to improve the accuracy of the machine learning models.

As a result of training or retraining a machine learning model on a remediation dataset, the weights or parameters of the machine learning model are changed and improved. The result of training or retraining is a new machine learning model having different weights or parameters that are fine tuned in view of the representativeness of the initial dataset. Accordingly, one or more embodiments provide for improving an existing machine learning model, thereby representing a technical solution to the above-identified technical problem.

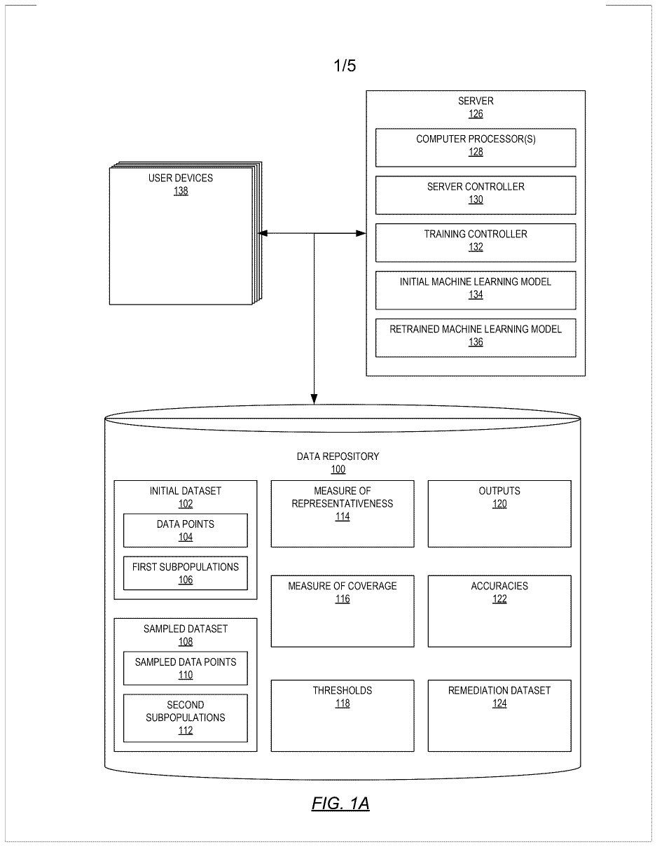

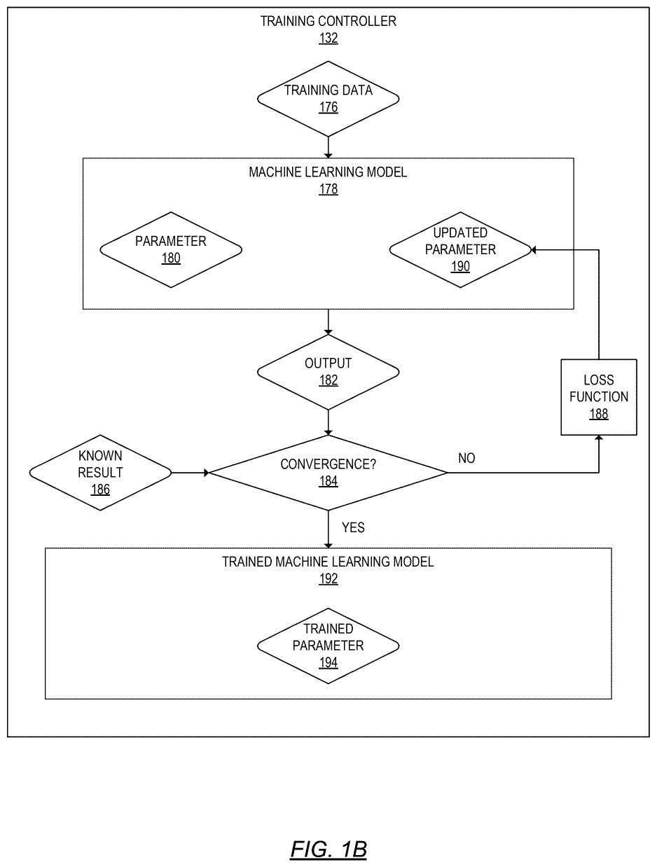

Attention is now turned to the figures. FIG. 1A and FIG. 1B show a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores an initial dataset (102). The initial dataset (102) is a set of data from which training data may be sampled, or the initial dataset (102) is a set of data for which machine learning predictions are to be made by the initial machine learning model (134). Thus, the initial dataset (102) may be a training dataset, as described above. The initial dataset (102) also may be referred to as a production dataset, as the initial dataset (102) may be generated as from the production traffic of an enterprise system.

The initial dataset (102) contains data points (104). Each of the data points (104) is a unit of information stored in the data repository (100) and associated with the initial dataset (102).

The initial dataset (102) may include first subpopulations (106) of data. The first subpopulations (106) are collections of two or more of the data points (104) that are related to each other in some way. For example, the first subpopulations (106) may be clusters of the data points (104), generated by a clustering algorithm.

The data repository (100) also stores a sampled dataset (108). The sampled dataset (108) is a set of data which is used to train or evaluate the initial machine learning model (134) (described below). The sampled dataset (108) may be sampled from the initial dataset (102). Alternatively, the sampled dataset (108) may be sampled from some other source of data that is deemed to be relevant to the initial dataset (102). The sampled dataset (108) may be a combination of sampling of the data points (104) from the initial dataset (102) and samplings of other sources of data.

The sampled dataset (108) includes sampled data points (110). The sampled data points (110) are units of information stored in the data repository (100) and associated with the sampled dataset (108).

The sampled dataset (108) may include second subpopulations (112). The second subpopulations (112) are collections of two or more of the sampled data points (110) that are related to each other in some way. For example, the second subpopulations (112) may be clusters of the sampled data points (110), generated by a clustering algorithm.

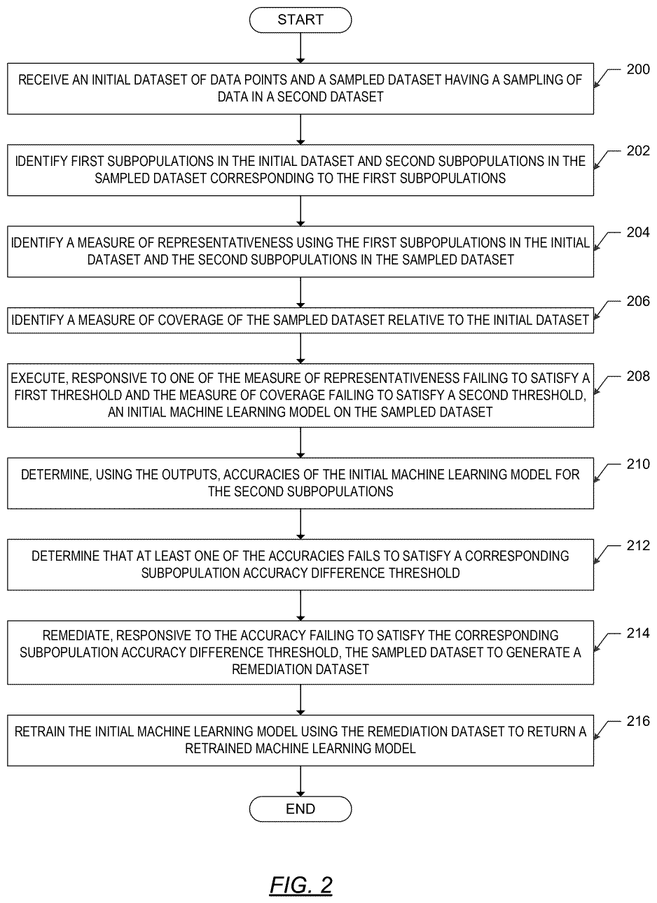

The second subpopulations (112) and the first subpopulations (106) may correspond to each other. For example, if the first subpopulations (106) include twelve clusters, the second subpopulations (112) may include twelve clusters of similar data types. One or more embodiments, particularly with respect to the method of FIG. 2, relate to determining how representative the sampled dataset (108) is of the initial dataset (102), and to remediate the sampled dataset (108) if the sampled dataset (108) is insufficiently representative of the initial dataset (102).

Thus, the data repository (100) may store a measure of representativeness (114). The measure of representativeness (114) is defined in terms of the proportions of subpopulations in the initial dataset (102) relative to the sampled dataset (108). Stated differently, representativeness is based on comparing the proportions of individual subpopulations in the initial and sampled datasets. For example, assume subpopulation A makes up 10% of the initial dataset (102) and 12% of the sampled dataset (108). In this case, the measure of representativeness would be based on comparing 10% to 12%. The measure of representativeness (114) may be performed for only one subpopulation. Thus, the measure of representativeness (114) may be calculated for only subpopulation A, though in most cases the measure of representativeness (114) is determined for each of the subpopulations in the initial dataset (102) and the sampled dataset (108).

More formally, the measure of representativeness (114) is a mathematical determination from the first subpopulations (106) and the second subpopulations (112). The determination of the measure of representativeness (114), and the mathematics thereof, are described with respect to step 204 in FIG. 2.

The data repository (100) also stores a measure of coverage (116). The measure of coverage (116) is defined as the fraction of pairs of the first subpopulations (106) and the second subpopulations (112) that are determined to meet a minimum threshold of the measure of representativeness (114). In other words, the measure of coverage (116) represents the number of pairs of the first subpopulations (106) and the second subpopulations (112) that meet a predetermined minimum acceptable representativeness. For example, if there are twelve clusters that define the first subpopulations (106) and a corresponding twelve clusters that define the second subpopulations (112), then there will be twelve pairs of clusters (the first pair being the first cluster in the first subpopulations (106) and the first cluster in the second subpopulations (112)). If all of the pairs of subclusters satisfy the minimum threshold representativeness, then the measure of coverage will be 1.0 (completely representative). However, if only six of the twelve pairs of subclusters satisfy the minimum threshold representativeness, then the measure of coverage will be 0.5.

More formally, the measure of coverage (116) is a mathematical determination from the first subpopulations (106) and the second subpopulations (112). The determination of the measure of coverage (116), and the mathematics thereof, are described with respect to step 206 in FIG. 2.

The data repository (100) also stores a number of thresholds (118). The thresholds (118) are numbers that represent a limit which is to be satisfied (met, exceeded, not exceeded, etc.). The thresholds (118) may be predetermined by a computer scientist or by an automated program. Use of the thresholds (118) is described with respect to FIG. 2.

For example, the thresholds (118) may include a “first threshold,” which represents a minimum acceptable value for the measure of representativeness (114). The thresholds (118) may include a “second threshold,” which represents a minimum acceptable value for the measure of coverage (116). The thresholds (118) also may include a “subpopulation accuracy difference threshold.” The subpopulation accuracy difference threshold is a maximum acceptable accuracy difference between the members of a pair of the subpopulations when the initial machine learning model (134) is applied to those members.

For example, assume that a first cluster of the first subpopulations (106) is paired with a second cluster of the second subpopulations (112). The first cluster and the second cluster are both provided as input to the initial machine learning model (134). The machine learning model generates a first output and a second output, accordingly. The first output is determined to have a first accuracy (i.e., the accuracy of the initial machine learning model (134) when generating an output from the first cluster). The second output is determined to have a second accuracy (i.e., the accuracy of the initial machine learning model (134) when generating an output from the second cluster). Ideally, the first accuracy and the second accuracy should match within an acceptable margin of error of model predictions if the first cluster and the second cluster have the same level of representativeness. The subpopulation accuracy difference threshold is the maximum acceptable difference between the accuracies among the data points in the first cluster and those in the second cluster.

The thresholds (118) also may include a “difference threshold.” The difference threshold is the maximum permitted difference in representativeness between a pair of subpopulations taken from the first subpopulations (106) and the second subpopulations (112), with respect to determining whether that pair of subpopulations is to be considered “close enough” to be considered to satisfy the coverage determination at step 206 of FIG. 2. Use of the difference threshold is described with respect to step 206 of FIG. 2.

The thresholds (118) also may include an accuracy difference threshold. The accuracy difference threshold is the minimum acceptable difference in accuracy of outputs of a model when a pair of subpopulations is input to the model.

The data repository (100) also stores a number of outputs (120). The outputs (120) are outputs of the initial machine learning model (134) (or the retrained machine learning model (136)) when the corresponding machine learning model is executed on an input. The input is the sampled dataset (108) or the initial dataset (102), or subpopulations thereof (i.e., the first subpopulations (106) or the second subpopulations (112)). The nature of the output depends on the type of machine learning model being used. For example, if the machine learning model is a classification model, then the output is a classification. If the machine learning model is a prediction model, then the output is a prediction. If the machine learning model is a language model, then the output is text generated by the machine learning model in response to a prompt that instructs the machine learning model how to process the input.

The data repository (100) also stores a number of accuracies (122). The accuracies (122) are accuracies of the outputs (120), as calculated by one or more machine learning models or as evaluated using a model specific evaluation metrics or criteria. For example, the outputs (120) may be known when the initial dataset (102) is a labeled training dataset. The accuracies (122) may be determined for each member of the first subpopulations (106) and the second subpopulations (112) by executing the initial machine learning model (134) (or the retrained machine learning model (136)) on each corresponding subpopulation.

The data repository (100) also may store a remediation dataset (124). The remediation dataset (124) is a set of data which is re-sampled for use in training the initial machine learning model (134). In one example, the remediation dataset (124) may be a re-sampling of the initial dataset (102). However, the remediation dataset (124) also may be a sampling from some other dataset, or a combination of sampling from the initial dataset (102) and some other dataset. In any case, the remediation dataset (124) will be used in place of the sampled dataset (108) when training the initial machine learning model (134). Use of the remediation dataset (124) is described with respect to step 214 and step 216 of FIG. 2.

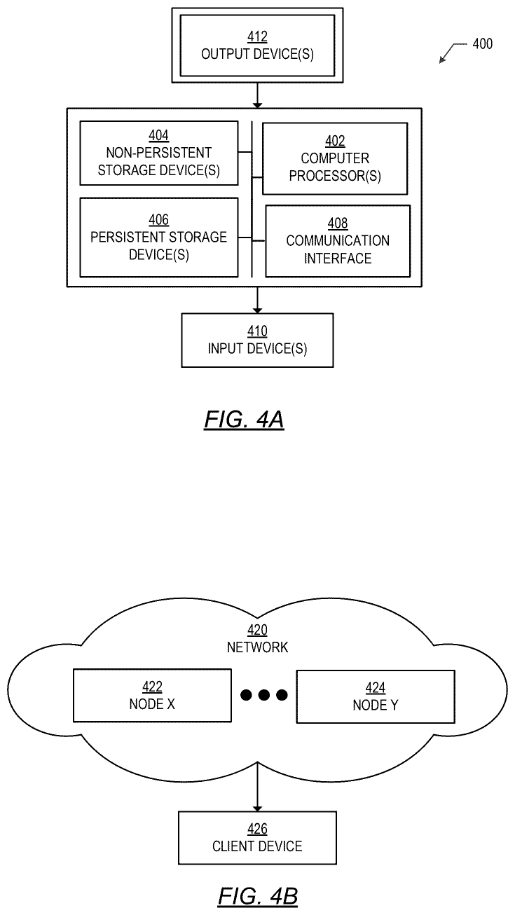

The system shown in FIG. 1A may include other components. For example, the system shown in FIG. 1A also may include a server (126). The server (126) is one or more computer processors, data repositories, communication devices, and supporting hardware and software. The server (126) may be in a distributed computing environment. The server (126) is configured to execute one or more applications, such as the server controller (130), the training controller (132), the initial machine learning model (134), and the retrained machine learning model (136). An example of a computer system and network that may form the server (126) is described with respect to FIG. 4A and FIG. 4B.

The server (126) includes one or more computer processor(s) (128). The computer processor(s) (128) is one or more hardware or virtual processors which may execute computer readable program code that defines one or more applications, such as the server controller (130), the training controller (132), the initial machine learning model (134), and the retrained machine learning model (136). An example of the computer processor(s) (128) is described with respect to the computer processor(s) (402) of FIG. 4A.

The server (126) also may include a server controller (130). The server controller (130) is software or application specific hardware which, when executed by the computer processor(s) (128), controls and coordinates operation of the software or application specific hardware described herein. Thus, the server controller (130) may control and coordinate execution of the training controller (132), the initial machine learning model (134), and the retrained machine learning model (136).

The server (126) also may include a training controller (132). The training controller (132) is software or application specific hardware which, when executed by the computer processor(s) (128), trains one or more machine learning models (e.g., the server controller (130), the training controller (132), the initial machine learning model (134), and the retrained machine learning model (136)). The training controller (132) is described in more detail with respect to FIG. 1B.

The system shown in FIG. 1A also may include one or more user devices (138). The user devices (138) are computing systems (e.g., the computing system (400) shown in FIG. 4A) that communicate with the server (126). The user devices (138) may be used to communicate with the server (126) when issuing commands to the server (126) to execute the method of FIG. 2.

The user devices (138) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

Attention is turned to FIG. 1B, which shows the details of the training controller (132). The training controller (132) is a training algorithm, implemented as software or application specific hardware, that may be used to train one or more of the machine learning models described with respect to the computing system of FIG. 1A, such as the initial machine learning model (134).

In general, machine learning models are trained prior to being deployed. The process of training a model, briefly, involves iteratively inferencing a model against training data for which the final result is known, comparing the inference results against the known results, and using the comparison to adjust the model parameters. The process is repeated until the comparison results do not improve more than some predetermined amount, or until some other termination condition occurs. After training, the final adjusted model is applied to unseen data (i.e., for which the actual result is not known) in order to make predictions.

Some machine learning models may be applied to vector data structures. A vector is a computer readable data structure. A vector may take the form of a matrix, an array, a graph, or some other data structure. However, a frequently used vector form is a one by N matrix, where each element of the matrix represents the value for one feature. As described above, a feature is an (independent) attribute of a data point (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the initial dataset (102), the data points (104), the first subpopulations (106), the sampled dataset (108), the sampled data points (110), the second subpopulations (112), and the remediation dataset (124) may be expressed as one or more vectors.

Returning to the operation of the training controller (132), training starts with training data (176), which may be expressed in vector form. The training data (176) may be the sampled dataset (108) or the remediation dataset (124) from FIG. 1A, expressed in vector form.

The training data may be labeled. The labels represent a known attribute associated with the data point for which practitioners would like a model to predict. Thus, a label applied to an instance of the output of the machine learning model may be “correct” or “incorrect” or a numerically assessed degree of correctness.

Thus, the training data (176) may be data for which the label has been acquired. If the prediction does not match the label, then the weights of the layers in the machine learning model (178) (e.g., the initial machine learning model (134) of FIG. 1A) may be updated and the training process iterated.

More generally, the training data (176) is provided as input to the machine learning model (178), which may be the initial machine learning model (134) of FIG. 1A. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of machine learning model (178) being used (supervised versus unsupervised machine learning), or may be predetermined by a user (e.g., convergence occurs after a set number of training iterations, described below).

In the case of supervised machine learning, the convergence process (184) compares the output (182) to a known result (186). The known result (186) is stored in the form of labels for the training data (176). For example, the known result (186) for a particular entry in an output (182) vector of the machine learning model (178) may be a known value, and that known value is a label that is associated with the training data (176).

Continuing the example of supervised machine learning model training, a determination is made whether the output (182) matches the known result (186) to a predetermined degree. The predetermined degree may be an exact match, a match to within a prespecified percentage, or some other metric for evaluating how closely the output (182) matches the known result (186). Convergence may occur when the known result (186) matches the output (182) to within a prespecified percentage. When many predictions are involved, then convergence may occur when more than a threshold number of predictions correctly match the corresponding labels.

In the case of unsupervised machine learning, the convergence process (184) may be compared to the output (182) or to a prior output in order to determine a degree to which the current output changed relative to the immediately prior output or to the original output. Once the degree of change fails to satisfy the threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). The program may be an algorithm which attempts to guess how the parameter (180) may be changed so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1B shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for improving the accuracy of a machine learning model, in accordance with one or more embodiments. The method of FIG. 2 may be implemented using the system of FIG. 1A and one or more of the steps may be performed on or received at one or more computer processors.

Step 200 includes receiving an initial dataset of data points and a sampled dataset having a sampling of data in a second dataset. Receiving the datasets may be performed by pulling or receiving the respective datasets from a data repository. In an embodiment, receiving the sampled dataset may include generating the sampling. Generating the sampling may be performed by sampling the initial dataset, by sampling some other dataset deemed to be related to the initial dataset, or some combination thereof.

Step 202 includes identifying first subpopulations in the initial dataset and second subpopulations in the sampled dataset corresponding to the first subpopulations. Identifying the subpopulations may include constructing distributions of subclusters in both datasets. Specifically, the distribution of the initial dataset and the sampled dataset may be constructed over a high-dimensional embedding space using one or more pre-trained embedding models. In other words, the initial and sampled datasets may be first embedded into an initial vector and a sampled vector using one or more embedding models. Then, the subpopulations in the two vectors may be identified using a dimensionality reduction followed by an optimal cluster identification algorithm.

In another embodiment, identifying the respective subpopulations may include identifying subpopulations that are already identified prior to step 202. However, identifying the respective subpopulations may include clustering the initial and sampled dataset using a clustering algorithm that is applied to both datasets. The allowed clusters may be predetermined so that there exists a one-to-one correspondence between clusters in the initial dataset and clusters in the sampled dataset. In other words, each cluster in the initial dataset may be associated with an associated cluster in the sampled dataset, thereby identifying a pair of subclusters to be compared to each other later in the method of FIG. 2.

Step 204 includes identifying a measure of representativeness using the first subpopulations in the initial dataset and the second subpopulations in the sampled dataset. For example, identifying the measure of representativeness may include comparing first numbers of data points within each of the first number of subpopulations to second numbers of data points within each of the second number of subpopulations. In other words, representativeness is based on comparing individual pairs of subpopulations in the initial and sampled datasets. The pairs of subpopulations are described above in step 202.

Continuing the comparing sub step of step 204, the comparing generates relative proportions of the first numbers to the second numbers for at least one pair of subpopulations. The at least one pair of subpopulations each include one member of the first number of subpopulations and another member of the second number of subpopulations. The measure of representativeness is the relative proportions for each of the at least one pair of subpopulations.

Attention is now turned to a more formal, mathematical definition of representativeness. First, the relative occurrence between the sampled dataset and the initial dataset is determined in each subpopulation (f_{j,e} and f_{j,p} defined below). Underrepresented subpopulations (e.g., e, p—those with significantly lower relative occurrence of evaluation dataset) may be identified using a representation threshold (τ). Formally, representativeness is defined as follows:

Let k be the number of subpopulations or clusters in the initial dataset. Within each cluster j where 0≤j≤k, there are eⱼ data points in the sampled dataset and pⱼ data points in the initial dataset, respectively. The proportion of the data points in each cluster can be defined as:

$$\begin{matrix}{f}_{j , e} = \frac{{e}_{j}}{{\sum }_{j = 1}^{k} {e}_{j}} = \frac{{e}_{j}}{{N}_{j}} for the sampled dataset , e . \\ and\end{matrix} \qquad ( 1 )$$

$${f}_{j , p} = \frac{{p}_{j}}{{\sum }_{j = 1}^{k} {p}_{j}} = \frac{{p}_{j}}{{N}_{p}} for the initial dataset , p . \qquad ( 2 )$$

If the initial distribution includes a stream of new data, then the initial distribution may be incrementally computed as new data points are streaming in.

In view of the above definitions in equations (1) and (2), the representativeness of a sampled dataset (Rₑ) is defined as the collection of the relative proportions of the sampled dataset relative to the initial dataset; specifically:

$${R}_{e} = \{ {r}_{j} \} , 0 \leq j \leq k where {r}_{j} = \frac{{f}_{j , e}}{{f}_{j , p}} \qquad ( 3 )$$

The representativeness of a subpopulation (cluster), j is rⱼ. The representativeness of the sampled dataset is Rₑ (the collection of rⱼ).

Step 206 includes identifying a measure of coverage of the sampled dataset relative to the initial dataset. Identifying the measure of coverage includes identifying at least one pair of subpopulations. The at least one pair of subpopulations each includes one member of the first number of subpopulations and another member of the second number of subpopulations. Identifying the measure of coverage includes identifying a fraction of the at least one pair of subpopulations that have no underrepresentation (i.e., are within or above a threshold representativeness fraction), as defined by representativeness in equation (3), above. Stated differently, a pair of the at least one pair of subpopulations has no underrepresentation when the representativeness of the pair is greater than a representativeness threshold. In this manner, a global view is generated, the global view being of the fraction of subpopulations that are represented based on a minimum representation threshold.

More formally, using the definitions provided above for equations (1), (2), and (3) in step 204, let τ be the representativeness threshold. In this case, the coverage, C, of a sampled dataset, e, is defined as:

$${C}_{e} = \frac{{\sum }_{j = 1}^{k} ( {r}_{j} > τ )}{k} \qquad ( 4 )$$

Step 208 includes executing, responsive to one of the measures of representativeness failing to satisfy a first threshold and the measure of coverage failing to satisfy a second threshold, an initial machine learning model on the sampled dataset. The first threshold is a predetermined maximum and/or minimum proportion permitted to exist within the relative proportions. The first threshold could be a minimum to capture underrepresentation. From the definition above, rⱼ could be low if the data points in subpopulation j,e make up a smaller share of the sampled dataset than data points in corresponding subpopulation j,p make up in the initial dataset. The first threshold could also be defined in terms of deviation from 1, which represents perfect representation or representativeness for a subpopulation. The second threshold is a predetermined minimum permitted fraction of the at least one pair of subpopulations that have no underrepresentation. Note that executing generates outputs corresponding to the second subpopulation.

The purpose of step 208 is to generate data for performing step 210. In some embodiments, the initial machine learning model may be executed individually on each of the subpopulations in both the initial dataset and the sampled dataset. In other words, the initial machine learning model is executed on each individual subpopulation in both datasets, and the accuracies of the outputs of the model are then compared to each other for pairs of the subpopulations. In other embodiments, the initial machine learning model is executed on the sampled dataset, and the accuracies of the resulting outputs of the model are compared with exogenous accuracies. Exogenous accuracies are accuracies received from an outside data source or defined in relationship to an external requirement. In any case, the accuracy of the initial machine learning model with respect to a subpopulation in the sampled dataset may be compared with a reference accuracy, and a difference in these accuracies assessed, as described more fully in step 210.

Step 210 includes determining, using the outputs, accuracies of the initial machine learning model for the second subpopulations. The accuracies of the model on the second subpopulations (i.e., second subpopulations in the sampled dataset) are evaluated in relation to the accuracies of the model on the first subpopulations (i.e., first subpopulations in the initial dataset that correspond to the second subpopulations), or in relation to exogenous accuracies.

A formal definition of determining the accuracies of the initial machine learning model at step 210 is now presented. To understand whether any given member of the second subpopulation in the sampled dataset might result in a relatively poorer model task performance, compared to the corresponding member of the first subpopulation in the initial dataset, task performance metrics (i.e. model accuracy) are aggregated over data points in each pair of subpopulations. To determine whether a particular performance is significantly under population average, the distribution of population performance metrics is built by bootstrapping.

Let a_{i,j} be the accuracy metric for data point iⱼ in subpopulation j. Subpopulation accuracy then can be defined as:

$$\begin{matrix}{a}_{{e}_{j}} = \frac{{\sum }_{i = 1}^{{N}_{j}} {a}_{{i}_{j} , j}}{{N}_{j}} where \\ {N}_{j} is the number of evaluation data points in cluster j\end{matrix} \qquad ( 5 )$$

Similarly, the mean and the standard deviation of accuracy over entire dataset can be defined as:

$$\begin{matrix}{a}_{e} = \frac{{\sum }_{j = 1}^{k} {a}_{{i}_{j} ,} {\sum }_{i = 1}^{{N}_{j}} {a}_{{i}_{j} ,}}{{\sum }_{j = 1}^{k} {N}_{j}} , \\ {S}^{2} = \frac{1}{{\sum }_{j = 1}^{k} {N}_{j}} {\sum }_{j = 1}^{k} {( {a}_{{i}_{j} ,} - {a}_{e} )}^{2} {\sum }_{i = 1}^{{N}_{j}} {( {a}_{{i}_{j} ,} - {a}_{e} )}^{2}\end{matrix} \qquad ( 6 )$$

The summary statistics in equation (6) may be used to determine whether a sampled subpopulation accuracy is significantly different from the corresponding initial subpopulation accuracy. For example, if the sampled subpopulation accuracy is more than 2 standard deviations (i.e., the threshold accuracy difference) lower than the initial subpopulation accuracy, then the given sampled subpopulation accuracy may be said to fail a subpopulation accuracy difference threshold in step 212, below.

Step 212 includes determining that at least one of the accuracies fails to satisfy a corresponding subpopulation accuracy difference threshold. In other words, at least one of the sampled subpopulations fails the subpopulation accuracy difference threshold. Because one or more sampled subpopulations that fail the subpopulation accuracy threshold, it may be said that the accuracy of the machine learning model, when executed on the sampled dataset, is unacceptably low.

Step 214 includes remediating, responsive to the accuracy failing to satisfy the corresponding subpopulation accuracy difference threshold, the sampled dataset to generate a remediation dataset. Sampling the new dataset is performed to cause the measure of representativeness for the remediated dataset to satisfy the first threshold and to cause the measure of coverage for the remediated dataset to satisfy the second threshold. In other words, the new dataset is sampled in such a way as to ensure that the first and second thresholds described above (i.e., the threshold for representativeness and the threshold for coverage) will be satisfied when evaluated according to the quantitative methods described above.

Generating the remediation dataset may be performed according to a number of different methods. In one embodiment, remediating the sampled dataset to generate the remediation dataset includes sampling a new dataset, different from the initial dataset, to generate the remediation dataset. In other words, a new dataset is sampled.

In another embodiment, remediating the sampled dataset to generate the remediation dataset may include re-sampling the initial dataset to generate the remediation dataset. For example, a different clustering algorithm could be used on the initial dataset or the union of the initial dataset and the sampled dataset in order to generate different clusters of subpopulations, a different sampling algorithm could be used on the initial data to generate a new sampling, or a combination thereof.

In still another embodiment, a more complex method may be used to generate the remediation dataset. For example, the more complex method may include executing an embedding machine learning model on the initial dataset to generate an embedded initial dataset. Then, a dimensionality reduction model is executed on the embedded version of the data points to generate a set of reduced dimension vectors, each representing one data point. A clustering model is executed on the reduced dimension vectors to generate an initial number of clusters of the data points. A sampling maximum (sampling budget) is determined, the sampling maximum being a total number of data points allowed to be in the remediated dataset. Then, from the sampling maximum, a predetermined minimum number of the data points is allocated to each of a remediated number of clusters on a cluster-by-cluster basis. Allocating reduces the sampling maximum to a reduced sampling maximum.

Then, a predetermined minimum number of the data points is allocated from the sampling maximum. Remaining data points in the reduced sampling maximum are distributed to the remediated number of clusters based on corresponding cluster densities of the remediated number of clusters and a specified proportional representation correction. After distributing, the remediated number of clusters is designated as the remediated dataset.

The method of generating the remediation dataset may be varied. For example, the remediation method above may include excluding, from the remediated dataset, first data points used in a training dataset of the remediated machine learning model. Additionally, the remediation method above may include excluding, from the remediated dataset, second data points present in the sampled dataset.

The remediation method described above also may include selecting, from the data points after distributing but before designating, cluster data points within each of the remediated number of clusters, such that the cluster data points are distributed at a maximized distance. The maximized distance may be each of the cluster data points being maximally distant from other cluster data points within a corresponding cluster of the remediated number of clusters. Distance is measured based on a distance measure between the cluster data points.

The remediated number of clusters may have a corresponding remediated number of cluster densities. The initial number of clusters may have an initial number of cluster densities. In this case, the corresponding remediated number of cluster densities may be about equal to the initial number of cluster densities.

More formally, the above more complex method for generating the remediation dataset may be presented as follows. To estimate the number of data points to sample per subpopulation, a technique known as Cochran's sample size estimation may be used. In Cochran's sample size estimation, the proportion of the subpopulation may be defined by a clusterwise relative occurrence, f_{j,p}, in the production distribution. More precisely,

$${N}_{j} = \frac{{Z}^{2} \cdot {f}_{j} ( 1 - {f}_{j} )}{{ME}_{j}^{2}} \qquad ( 7 )$$

where Z is the z-score associated with a desired margin of error (ME).

Given a production data distribution with subpopulations identified and desired number of data points N, the generation of a remediation dataset may be cast as a capacitated facility location problem (CFLP), in which the optimization objective is to minimize the distance from individual data points in the initial dataset to their closest “representative.” To achieve this goal, optimal clusters of the production data points may be found in the embedding space. The resulting clustering is ranked by density.

Optimal clusters may be determined using semi-supervised objectives using a semi-supervised machine learning algorithm. Among the data points with prior information (indicating which clusters should be together or separate), a contrastive objective may be used to divide the clusters. Among data points without prior information, clusters may be created with varying hyperparameters (such as the number of clusters) and cluster quality measures (such as Gap statistics).

The clusters may be the same as the subpopulations identified earlier. To help ensure representation across subpopulations (i.e., the clusters), at least j data points are allocated per cluster to all the clusters. Then, the remaining sampling budget (i.e., the number of data points to be sampled and labeled N−j×k) is proportionally distributed to different clusters based on the cluster density (i.e., the percentage of the number of data points in the cluster relative to the entire population). Within the cluster, individual sampling points are distributed as far apart as possible while capturing about the same amount of density within a cluster.

Step 216 includes retraining the initial machine learning model, using the remediation dataset, to return a retrained machine learning model. Retraining may be performed as described with respect to FIG. 1B. However, the training data is now the remediation dataset. Retraining the initial machine learning model changes the weights, parameters, hyperparameters, or other changeable aspects of the machine learning model. As a result, the model is more accurate when using a sampled dataset as input to generate predictions regarding an initial dataset. In this manner, the machine learning model is improved, and hence the computer itself is capable of greater accuracy relative to using the sampled dataset to generate predictions about the initial dataset before performing the method of FIG. 2.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

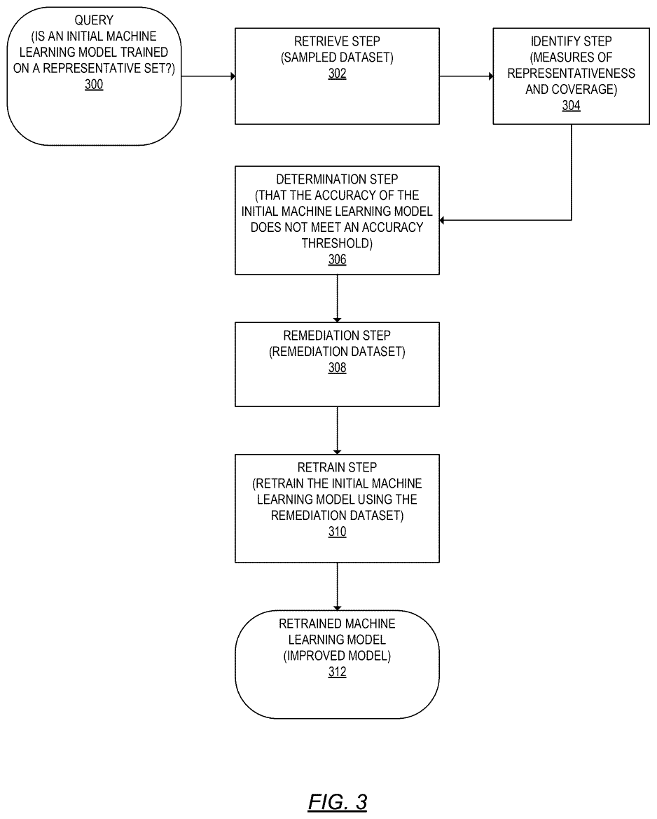

FIG. 3 shows an example of improving the accuracy of an initial machine learning model, in accordance with one or more embodiments. The following example is for explanatory purposes only and not intended to limit the scope of one or more embodiments.

Initially, a query (300) is received. The query is specifically a query on whether the initial machine learning model is trained on a representative dataset (i.e., is the sampled dataset representative of the initial dataset).

At retrieve step (302), a sampled dataset is received or retrieved. Then, at identify step (304), the measures of representativeness and coverage are generated. Representativeness and coverage redefined with respect to FIG. 1A. Generation of the measures of representativeness and coverage are described above with respect to FIG. 2.

At determination step (306), a determination is made that the accuracy of the initial machine learning model does not meet an accuracy threshold. The accuracy may be determined by executing the initial machine learning model on subpopulations in the initial dataset and corresponding subpopulations in the sampled dataset, as described with respect to step 208 of FIG. 2. However, as indicated above, the accuracies for the sampled dataset may be compared with exogenous accuracies.

At remediation step (308), a remediation dataset is generated. Generation of the remediation dataset is described with respect to step 214 of FIG. 2.

At retrain step (310), the initial machine learning model is retrained using the remediation dataset. Retraining the machine learning model is described with respect to FIG. 1B, where the remediation dataset is the new training dataset.

After retraining (i.e., after convergence), the initial machine learning model becomes the retrained machine learning model (312). The retrained machine learning model (312) is an improved model, because the adjusted weights, parameters, hyperparameters, etc. of the retrained machine learning model (312) will generate more accurate predictions on the initial dataset, relative to the initial machine learning model. Note that the retrained machine learning model (312) is a different model, for while the algorithm itself may not have changed, the retrained machine learning model (312) is changed (via adjusted weights, parameters, hyperparameters, etc.) relative to the initial machine learning model, and thereby produces different (improved) outputs than the initial machine learning model.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426).

For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving an initial dataset of data points and a sampled dataset comprising a sampling of data in a second dataset;
identifying a first plurality of subpopulations in the initial dataset and a second plurality of subpopulations in the sampled dataset corresponding to the first plurality of subpopulations;
identifying a measure of representativeness using the first plurality of subpopulations in the initial dataset and the second plurality of subpopulations in the sampled dataset;
identifying a measure of coverage of the sampled dataset relative to the initial dataset;
executing, responsive to one of the measure of representativeness failing to satisfy a first threshold and the measure of coverage failing to satisfy a second threshold, an initial machine learning model on the sampled dataset, wherein executing generates a plurality of outputs corresponding to the second plurality of subpopulations;
determining, using the plurality of outputs, a plurality of accuracies of the initial machine learning model for the second plurality of subpopulations;
determining that at least one of the plurality of accuracies fails to satisfy a corresponding subpopulation accuracy difference threshold;
remediating, responsive to the accuracy failing to satisfy the corresponding subpopulation accuracy difference threshold, the sampled dataset to generate a remediation dataset; and
retraining the initial machine learning model using the remediation dataset to return a retrained machine learning model.

2. The method of claim 1,
wherein identifying the measure of representativeness comprises comparing first numbers of data points within each of the first plurality of subpopulations to second numbers of data points within each of the second plurality of subpopulations,
wherein comparing generates relative proportions of the first numbers to the second numbers for at least one pair of subpopulations,
wherein the at least one pair of subpopulations each comprise one member of the first plurality of subpopulations and another member of the second plurality of subpopulations, and
wherein the measure of representativeness comprises the relative proportions for each of the at least one pair of subpopulations.

3. The method of claim 2, wherein the first threshold comprises a predetermined maximum proportion permitted to exist within the relative proportions.

4. The method of claim 1, wherein:
identifying the measure of coverage comprises identifying at least one pair of subpopulations,
the at least one pair of subpopulations each comprise one member of the first plurality of subpopulations and another member of the second plurality of subpopulations,
identifying the measure of coverage further comprises identifying a fraction of the at least one pair of subpopulations that have no underrepresentation, and
a pair of the at least one pair of subpopulations has no underrepresentation when the measure of representativeness of the pair is greater than a representativeness threshold.

5. The method of claim 4, wherein the second threshold comprises a predetermined minimum permitted fraction of the at least one pair of subpopulations that have no underrepresentation.

6. The method of claim 1, wherein:
remediating comprises sampling a new dataset, different than the initial dataset, to generate the remediation dataset, and
sampling the new dataset is performed to cause the measure of representativeness for the remediated dataset to satisfy the first threshold and to cause the measure of coverage for the remediated dataset to satisfy the second threshold.

7. The method of claim 1, wherein:
remediating comprises re-sampling the initial dataset to generate the remediation dataset, and
re-sampling is performed to cause the measure of representativeness for the remediated dataset to satisfy the first threshold and to cause the measure of coverage for the remediated dataset to satisfy the second threshold.

8. The method of claim 1, wherein remediating comprises:
executing an embedding machine learning model on the initial dataset to generate an embedded initial dataset,
executing a dimensionality reduction model on the embedded initial dataset to generate a reduced dimension vector,
executing a clustering model on the reduced dimension vector to generate an initial plurality of clusters of the data points,
determining a sampling maximum comprising a total number of data points allowed to be in the remediated dataset,
allocating, from the sampling maximum, a predetermined minimum number of the data points to each of a remediated plurality of clusters on a cluster-by-cluster basis, wherein allocating reduces the sampling maximum to a reduced sampling maximum,
distributing remaining data points in the reduced sampling maximum to the remediated plurality of clusters based on corresponding cluster densities of the remediated plurality of clusters and a specified proportional representation correction, and
designating, after distributing, the remediated plurality of clusters as the remediated dataset.

9. The method of claim 8, wherein the method further comprises:
excluding, from the remediated dataset, first data points used in a training dataset of the retrained machine learning model; and
excluding, from the remediated dataset, second data points present in the sampled dataset.

10. The method of claim 8, wherein remediating further comprises:
selecting, from the data points after distributing but before designating, cluster data points within each of the remediated plurality of clusters such that the cluster data points are distributed at a maximized distance.

11. The method of claim 10,
wherein the maximized distance comprises each of the cluster data points being maximally distant from other cluster data points within a corresponding cluster of the remediated plurality of clusters, and
wherein distance is measured based on a distance measure between the cluster data points.

12. The method of claim 8,
wherein the remediated plurality of clusters comprises a corresponding remediated plurality of cluster densities,
wherein the initial plurality of clusters comprises an initial plurality of cluster densities, and
wherein the corresponding remediated plurality of cluster densities is about equal to the initial plurality of cluster densities.

13. A system comprising:
a computer processor;
a data repository in communication with the computer processor and storing:
an initial dataset of data points,
a sampled dataset comprising a sampling of data in a second dataset, a first plurality of subpopulations in the initial dataset,
a second plurality of subpopulations in the sampled dataset corresponding to the first plurality of subpopulations,
a measure of representativeness having a first threshold,
a measure of coverage of the sampled dataset relative to the initial dataset, having a second threshold
a plurality of outputs corresponding to the second plurality of subpopulations,
a plurality of accuracies of an initial machine learning model for the second plurality of subpopulations, and
a remediation dataset;
the initial machine learning model which, when executed by the computer processor on the sampled dataset responsive to one of the measure of representativeness failing to satisfy the first threshold and the measure of coverage failing to satisfy the second threshold, generates the plurality of outputs;
a retrained machine learning model executable by the computer processor;
a server controller in communication with the computer processor which, when executed by the computer processor:
identifies the initial dataset, the sampled dataset, the first plurality of subpopulations, the second plurality of subpopulations,
identifies the measure of representativeness using the first plurality of subpopulations and the second plurality of subpopulations,
identifies the measure of coverage,
determines the plurality of accuracies using the plurality of outputs of the initial machine learning model,
determines that at least one of the plurality of accuracies fails to satisfy a corresponding subpopulation accuracy difference threshold, and
remediates, responsive to the accuracy failing to satisfy the corresponding subpopulation accuracy difference threshold, the sampled dataset to generate the remediation dataset; and
a training controller in communication with the computer processor which, when executed by the computer processor, retrains the initial machine learning model using the remediation dataset to return the retrained machine learning model.

14. The system of claim 13, wherein the computer processor remediates the sampled dataset by:
executing an embedding machine learning model on the initial dataset to generate an embedded initial dataset,
executing a dimensionality reduction model on the embedded initial dataset to generate a reduced dimension vector,
executing a clustering model on the reduced dimension vector to generate an initial plurality of clusters of the data points,
determining a sampling maximum comprising a total number of data points allowed to be in the remediated dataset,
allocating, from the sampling maximum, a predetermined minimum number of the data points to each of a remediated plurality of clusters on a cluster-by-cluster basis, wherein allocating reduces the sampling maximum to a reduced sampling maximum,
distributing remaining data points in the reduced sampling maximum to the remediated plurality of clusters based on corresponding cluster densities of the remediated plurality of clusters and a specified proportional representation correction, and
designating, after distributing, the remediated plurality of clusters as the remediated dataset.

15. The system of claim 14, wherein the server controller is further configured to remediate the sampled dataset by:
excluding, from the remediated dataset, first data points used in a training dataset of the retrained machine learning model, and
excluding, from the remediated dataset, second data points present in the sampled dataset.

16. The system of claim 14, wherein the server controller is further configured to remediate the sampled dataset by:
selecting, from the data points after distributing but before designating, cluster data points within each of the remediated plurality of clusters such that the cluster data points are distributed at a maximized distance.

17. The system of claim 16,
wherein the maximized distance comprises each of the cluster data points being maximally distant from other cluster data points within a corresponding cluster of the remediated plurality of clusters, and
wherein distance is measured based on a distance measure between the cluster data points.

18. The system of claim 14,
wherein the remediated plurality of clusters comprises a corresponding remediated plurality of cluster densities,
wherein the initial plurality of clusters comprises an initial plurality of cluster densities, and
wherein the corresponding remediated plurality of cluster densities is about equal to the initial plurality of cluster densities.

19. A method comprising:
receiving an initial dataset of data points and a sampled dataset comprising a sampling of data in a second dataset;
identifying a first plurality of subpopulations in the initial dataset and a second plurality of subpopulations in the sampled dataset corresponding to the first plurality of subpopulations;
identifying a measure of representativeness using the first plurality of subpopulations in the initial dataset and the second plurality of subpopulations in the sampled dataset by comparing first numbers of data points within each of the first plurality of subpopulations to second numbers of data points within each of the second plurality of subpopulations, wherein:
comparing generates relative proportions of the first numbers to the second numbers for at least one pair of subpopulations,
the at least one pair of subpopulations each comprise one member of the first plurality of subpopulations and another member of the second plurality of subpopulations, and
the measure of representativeness comprises the relative proportions for each of the at least one pair of subpopulations;
identifying a measure of coverage of the sampled dataset relative to the initial dataset by identifying at least one pair of subpopulation, wherein:
the at least one pair of subpopulations each comprise one member of the first plurality of subpopulations and another member of the second plurality of subpopulations,
identifying the measure of coverage further comprises identifying a fraction of the at least one pair of subpopulations that have no underrepresentation, and
a pair of the at least one pair of subpopulations has no underrepresentation when the measure of representativeness of the pair is greater than a representativeness threshold;
executing, responsive to one of the measure of representativeness failing to satisfy a first threshold and the measure of coverage failing to satisfy a second threshold, an initial machine learning model on the sampled dataset, wherein executing generates a plurality of outputs corresponding to the second plurality of subpopulations;
determining, using the plurality of outputs, a plurality of accuracies of the initial machine learning model for the second plurality of subpopulations;
determining that at least one of the plurality of accuracies fails to satisfy a corresponding subpopulation accuracy difference threshold;
remediating, responsive to the accuracy failing to satisfy the corresponding subpopulation accuracy difference threshold, the sampled dataset to generate a remediation dataset by performing at least one of sampling a new dataset and re-sampling the initial dataset to cause the measure of coverage for the remediated dataset to satisfy the second threshold; and
retraining the initial machine learning model using the remediation dataset to return a retrained machine learning model.

20. The method of claim 19,
wherein the first threshold comprises a predetermined maximum proportion permitted to exist within the relative proportions, and
wherein the second threshold comprises a predetermined minimum permitted fraction of the at least one pair of subpopulations that have no underrepresentation.
